(19) United States
(12) Patent Application Publication
(10) Pub. No.: US 2007/0206657 A1
(43) Pub. Date: Sep. 6, 2007

(54) Probe structure

(76) Inventors: Kevin Lin, HsinChu (TW); Vincent Weng, HsinChu (TW); Joy Liao, Sansing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/590,886

(22) Filed: Nov. 1, 2006

(30) Foreign Application Priority Data
Mar. 3, 2006 (TW) 95107218

(51) Int. Cl. G01K 1/00

(52) U.S. Cl. 374/208

(57) ABSTRACT

The present invention discloses an improved probe structure, which comprises: a casing having an opening; a sleeve arranged inside the casing and around the opening; a temperature sensor installed inside the sleeve; a curved solid circularly arranged along the inner rim of the opening and above the temperature sensor. Owing to the curved solid, the detection angle can be reduced, and the detected temperature is closer to the eardrum temperature; further, the gap between the casing and the temperature sensor can be decreased, and the volume of the probe structure can be reduced.

### BACKGROUND OF THE INVENTION

1. Field of the Invention

The present invention relates to an improved probe structure for an infrared clinical thermometer, particularly for an improved probe structure, which has a smaller probe volume and a higher measurement accuracy.

2. Description of the Related Art

In principle, the ear thermometer determines the body temperature via detecting the infrared radiation from the eardrum. The eardrum is located inside the skull and near the hypothalamus—the thermoregulation center in the brain, and both shares the blood supplied by the carotid artery; therefore, the eardrum can instantly reflect the variation of core body temperature. The eardrum temperature can be further converted into a rectal or oral temperature. As the ear thermometer has the advantages of rapidity, simplicity, and accuracy, it has become the mainstream of body temperature measurement.

In the conventional probe structures of the ear thermometers, the infrared sensor is supported by a support member and receives the thermal radiation transmitted by a waveguide (crystal tube). The support member may be an assembled structure or a one-piece element. A casing encases the infrared sensor and the support member. When the infrared sensor is measuring temperature, it absorbs thermal radiation, and the temperature thereof rises. However, the heat in the infrared sensor dissipates less easily owing to the minor gap between the support member and the casing. In the succeeding measurements, the temperature difference between the casing and the infrared sensor will interfere with the measurement. Such a conventional probe structure has been disclosed in U.S. Pat. No. 6,386,757 and U.S. Pat. No. 6,152,595.

A Taiwan patent No. M266029 proposed an “Improved Ear Thermometer Structure, Part 2” to solve the abovementioned problems, wherein the infrared sensor is disposed at the front end of the interior of the probe. Thus, the temperature difference between the infrared sensor and the environment is greatly reduced, and the cost of the waveguide is also saved. However, such a probe structure brings about an additional measurement problem. The ear thermometer is to measure the temperature of the eardrum. When the infrared sensor is disposed at the front end of the probe, the infrared light received by the infrared sensor propagates is in a scattered state. This causes that the infrared light received by the infrared sensor is not emitted from the eardrum but emitted from the ear canal in the periphery of the eardrum. Therefore, the body temperature measured by this conventional technology is not so accurate, and the solution for such a measurement error is being aspired after currently.

Accordingly, the present invention proposes an improved probe structure to effectively overcome the abovementioned problems.

### SUMMARY OF THE INVENTION

The primary objective of the present invention is to provide an improved probe structure, wherein a curved solid is disposed around the inner rim of the opening of the probe and used to control the detection angle of the temperature sensor and improve the measurement accuracy of the infrared clinical thermometer.

Another objective of the present invention is to provide an improved probe structure, wherein a curved solid is used to lessen the sensitivity to thermal conduction and decrease the gap between the probe casing and the temperature sensor and thus reduce the volume of the probe structure.

According to one aspect of the present invention, the improved probe structure, which is installed on the body of an infrared clinical temperature, comprises: a casing with an opening; a sleeve arranged inside the casing and along the opening; a temperature sensor installed inside the sleeve; and a curved solid circularly arranged along the inner rim of the opening and above the temperature sensor, wherein the curved surface of the curved solid can reduce the measurement interference of the temperature sensor.

To enable the objectives, technical contents, characteristics and accomplishments of the present invention to be easily understood, the embodiments of the present invention are to be described in detail in cooperation with attached drawings below.

### BRIEF DESCRIPTION OF THE DRAWINGS

FIG. 1 is a sectional view schematically showing the improved probe structure according to a first embodiment of the present invention;

FIG. 2 is a partially enlarged sectional view schematically showing the improved probe structure according to the first embodiment of the present invention;

FIG. 3 is a diagram schematically showing the operation of the ear thermometer with the probe structure of the present invention according to the first embodiment of the present invention; and

FIG. 4 is a sectional view schematically showing the improved probe structure according to a second embodiment of the present invention.

### DETAILED DESCRIPTION OF THE INVENTION

The present invention discloses an improved probe structure, which is installed on the body of an infrared clinical thermometer. The infrared clinical thermometer may be a forehead thermometer or an ear thermometer. Two embodiments described herein are both illustrated with the improved probe structures for an ear thermometer. Via the improved probe structure of the present invention, the ear thermometer can measure body temperature more accurately.

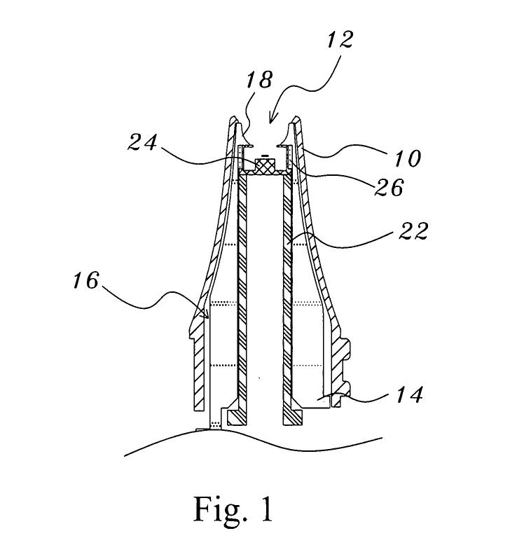

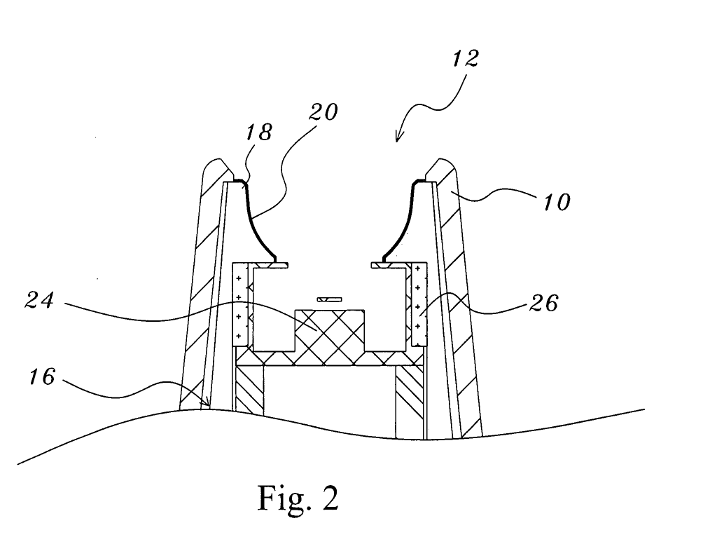

Refer to FIG. 1 and FIG. 2 for the improved probe structure according to a first embodiment of the present invention. According to this embodiment, the improved probe structure of the present invention comprises: a casing 10, which is made of a plastic material and has an opening 12; a sleeve 14, which is made of a metallic material and installed inside the casing 10 and fixed to the inner rim of the opening 12 by an ultrasonic bonding method, wherein a gap 16 is formed between the sleeve 14 and the casing 10 and used to enhance thermal insulation; a curved solid 18, which is circularly disposed along the inner rim of the top end of the sleeve 14 and has an curvature of 30˜85 degrees and has a coating 20 on the surface thereof, wherein the coating 20 is used to reduce the radiation of infrared light and promote the reflectivity of infrared light, and the curved solid 18 and the sleeve 14 are fabricated into a one-piece element; a support element 22, which is a tube-like element and installed inside the sleeve 14; a temperature sensor 24, which is supported by the support element 22 and disposed between the support element 22 and the curved solid 18, wherein the curved solid 18 is circularly arranged above the temperature sensor 24; and a thermal insulation ring 26, which is installed between the sleeve 14 and the casing 10 and surrounds the perimeter of the temperature sensor 24 to enhance thermal insulation.

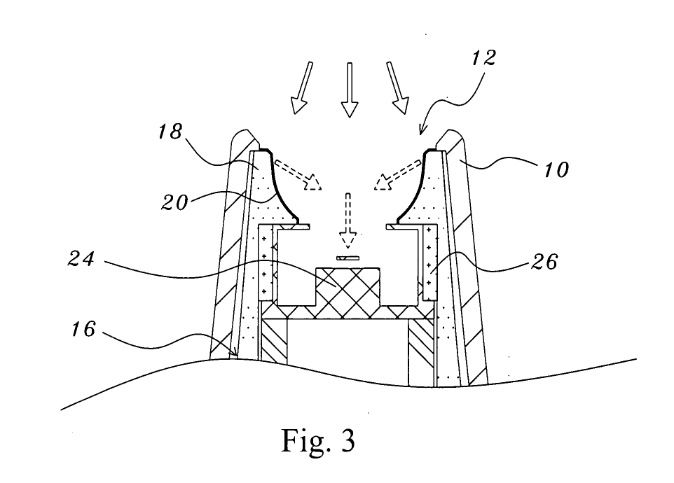

Refer to FIG. 3 for the operation of the ear thermometer with the probe structure of the present invention. When the probe structure of the present invention is inserted into the ear canal, the infrared light incidents on the coating 20 of the curved solid 18 and then reflects from the coating 20 into the temperature sensor 24; thereby, the received infrared light can be focused and thus the scattering angles of the infrared light decrease, and the area detected by the temperature sensor 24 is thus restricted; therefore, the measurement interference is reduced, and temperature can be more accurately measured.

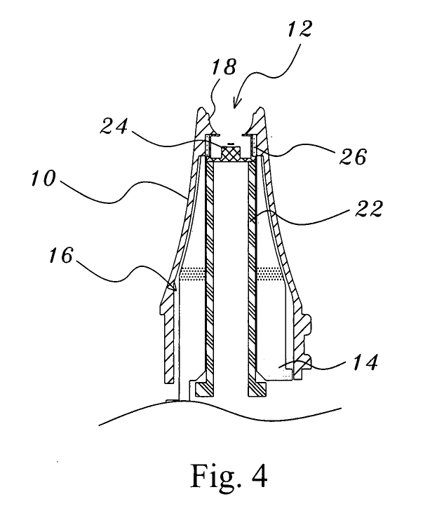

Refer to FIG. 4 for the improved probe structure according to a second embodiment of the present invention. In contrast to the first embodiment, the curved solid 18 is arranged along the inner rim of the opening 12 of the casing 10 in the second embodiment. The curved solid 18 and the casing 10 are fabricated into a one-piece element in this embodiment. Via arranging the curved solid 18 along the inner rim of the opening 12, the gap 16, which is originally formed between the casing 10 and the sleeve 14 and near the opening 12, can be omitted; thus, the volume of the probe structure can be further reduced.

In summary, no matter whether the curved solid is installed in the interior of the casing or the sleeve, the curved solid can reduce the detection angle, and thus, the detected temperature can be closer to the eardrum temperature. Further, the curved solid can lessen the sensitivity to thermal conduction; thus, the gap between the casing and the temperature sensor can be decreased, and the volume of the probe structure can be reduced.

Those embodiments described above are to clarify the present invention to enable the persons skilled in the art to understand, make and use the present invention. However, it is not intended to limit the scope of the present invention. Any equivalent modification and variation without departing from the spirit of the present invention is to be also included within the scope of the present invention.

What is claimed is:

1. An improved probe structure, installed on the body of an infrared clinical thermometer, comprising:
a casing having an opening;
a sleeve installed inside said casing and along the perimeter of said opening; and
a temperature sensor installed inside said sleeve;
and characterized in:
a curved solid is circularly arranged along the inner rim of said opening and above said temperature sensor; via said curved solid, the detection angle is reduced, and the detected temperature is closer to the eardrum temperature.

2. The improved probe structure according to claim 1, wherein said sleeve is made of metallic material.

3. The improved probe structure according to claim 1, wherein a support element is installed inside said sleeve and used to support said temperature sensor.

4. The improved probe structure according to claim 3, wherein said temperature sensor is supported by said support element and positioned between said curved solid and said support element.

5. The improved probe structure according to claim 1, wherein said sleeve is fixed to said casing with an ultrasonic bonding method.

6. The improved probe structure according to claim 1, wherein said infrared clinical thermometer is a forehead thermometer or an ear thermometer.

7. The improved probe structure according to claim 1, wherein a gap is formed between said casing and said sleeve and used to block the interference of the environmental temperature.

8. The improved probe structure according to claim 1, wherein the curvature of the surface of said curved solid is within 30˜85 degrees.

9. The improved probe structure according to claim 1, wherein said curved solid and said casing are fabricated into a one-piece element.

10. The improved probe structure according to claim 1, wherein said curved solid and said sleeve are fabricated into a one-piece element.

11. The improved probe structure according to claim 1, wherein said casing is made of plastic material.

12. The improved probe structure according to claim 1, wherein said curved solid is arranged along the inner rim of said casing or said sleeve.

13. The improved probe structure according to claim 1, wherein the curved surface of said curved solid has a coating used to reduce the radiation of infrared light and promote the reflectivity of infrared light.

14. The improved probe structure according to claim 1, wherein a thermal insulation ring is installed between said sleeve and said casing and surrounds the perimeter of said temperature sensor.
